(19) United States
(12) Patent Application Publication
(10) Pub. No.: US 2022/0041829 A1
(43) Pub. Date: Feb. 10, 2022

(54) PRODUCTION OF RIGID POLYURETHANE FOAM

(71) Applicant: Evonik Operations GmbH, Essen (DE)

(72) Inventors: Martin Glos, Borken (DE); Jobst Grimminger, Ellerau (DE); Michael Ferenz, Essen (DE)

(73) Assignee: Evonik Operations GmbH, Essen (DE)

(21) Appl. No.: 17/414,726

(22) PCT Filed: Dec. 16, 2019
(86) PCT No.: PCT/EP2019/085264

§ 371 Date: Jun. 16, 2021

(30) Foreign Application Priority Data
Jan. 7, 2019 (EP) 19150465.3

(51) Int. Cl. C08J 9/00; C08L 75/06; C08J 9/14

(52) U.S. Cl. CPC C08J 9/0061; C08L 75/06; C08J 9/141; C08L 2203/14; C08L 2205/025; C08J 2483/06; C08L 2201/08; C08J 2203/14; C08J 2203/16; C08J 2205/10; C08J 2375/06; C08L 2205/03

(57) ABSTRACT

What are described are (a) a composition suitable for production of rigid polyurethane foam, comprising at least one isocyanate component, a polyol component, optionally a catalyst that catalyses the formation of a urethane or isocyanurate bond, optionally blowing agents, where the composition additionally comprises hydrocarbons HC, polyether-modified siloxane and optional polyalkylsiloxane, (b) a process for producing rigid polyurethane foam using hydrocarbons HC, polyether-modified siloxane and optional polyalkylsiloxanes, (c) the rigid polyurethane foam thus obtainable and (d) the use thereof.

### CROSS REFERENCE TO RELATED APPLICATIONS

This application is a 35 U.S.C. § 371 U.S. national phase entry of International Application No. PCT/EP2019/085264 having an international filing date of Dec. 16, 2019, which claims the benefit of European Application No. 19150465.3 filed Jan. 7, 2019, both of which are incorporated herein by reference in its entirety.

### FIELD

The present invention is in the field of rigid polyurethane foams. More particularly, it relates to the production of rigid polyurethane foams using specific siloxane compounds in combination with hydrocarbons, and additionally to the use of the foams which have been produced therewith.

### BACKGROUND

Polyurethane (PU) in the context of the present invention is especially understood to mean a product obtainable by reaction of polyisocyanates and polyols, or compounds having isocyanate-reactive groups. Further functional groups in addition to the polyurethane can also be formed in the reaction, examples being uretdiones, carbodiimides, isocyanurates, allophanates, biurets, ureas and/or uretonimines. Therefore, PU is understood in the context of the present invention to mean both polyurethane and polyisocyanurate, polyureas, and polyisocyanate reaction products containing uretdione, carbodiimide, allophanate, biuret and uretonimine groups. In the context of the present invention, polyurethane foam (PU foam) is especially understood to mean foam which is obtained as reaction product based on polyisocyanates and polyols or compounds having isocyanate-reactive groups. The reaction to give what is named a polyurethane can form further functional groups as well, examples being allophanates, biurets, ureas, carbodiimides, uretdiones, isocyanurates or uretonimines.

Rigid polyurethane and polyisocyanurate foams are usually produced using cell-stabilizing additives to ensure a fine-celled, uniform and low-defect foam structure and hence to exert an essentially positive influence on the performance characteristics, particularly the thermal insulation performance, of the rigid foam. Surfactants based on polyether-modified siloxanes are particularly effective and therefore represent the preferred type of foam stabilizers.

Hydrocarbons are often used here as blowing agents. Preference is given here to using compounds having 3 to 7 carbons since these have their boiling points within the appropriate temperature range, such that they evaporate in the foaming process and hence contribute to an increase in volume, i.e. to formation of foam. In the finished foam, these blowing agents are then still present in the foam as cell gas.

Various publications relating to the use of siloxane-based additives have already been published. Usually, polyethersiloxane foam stabilizers (PES) are used here for rigid foam applications.

EP 0 570 174 B1 describes polyethersiloxanes suitable for the production of rigid polyurethane foams using organic blowing agents, particularly chlorofluorocarbons such as CFC-11.

EP 0 533 202 A1 describes polyethersiloxanes that bear SiC-bonded polyalkylene oxide radicals and are suitable as blowing agent in the case of use of hydrochlorofluorocarbons, for example HCFC-123.

EP 0 877 045 B1 describes analogous structures for this production process which differ from the former foam stabilizers in that they have a comparatively higher molecular weight and have a combination of two polyether substituents on the siloxane chain.

EP1544235 describes typical polyether-modified siloxanes for rigid PU foam applications. Siloxanes having 60 to 130 silicon atoms and different polyether substituents R, the mixed molar mass of which is 450 to 1000 g/mol and the ethylene oxide content of which is 70 to 100 mol %, are used here.

CN103055759 describes polyether-modified siloxanes that bring about improved cell opening. At least 18 silicon units are present in the siloxane, and various types of side chains are used for modification.

EP 1873209 describes polyether-modified siloxanes for production of rigid PU foams having improved fire properties. Here there are 10 to 45 silicon atoms in the siloxanes, and the polyether side chains consist to an extent of at least 90% of ethylene oxide units.

EP 2465891 A1 describes polyether-modified siloxanes in which some of the polyether side chains bear OH groups. The siloxanes here contain at least 10 silicon atoms.

EP 2465892 A1 describes polyether-modified siloxanes in which the polyether side chains bear mainly secondary OH end groups. Here too, the siloxanes contain at least 10 silicon atoms.

DE 3234462 describes siloxanes for use in flexible foam, especially moulded flexible foam. There are descriptions here of combinations of polyether-modified siloxanes (PES) and polydimethylsiloxanes, where the PES contain 4-15 silicon units. There is no description here of use in rigid foam.

The use of hydrocarbons having a maximum of 7 carbons is described in numerous documents.

US 20110218259 describes the use of cyclopentane in rigid PU foam systems having improved flowability, as required, for example, in the production of cooling units or panels.

EP 421269 describes the use of cyclopentane and mixtures thereof with cyclohexane and various hydrocarbons having max. 4 carbons, and ethers and fluoroalkanes having a boiling point of less than 35° C. What are used here are thus hydrocarbons that all evaporate in the course of PU foaming and hence serve as blowing agents.

WO 2016202912 describes various hydrocarbons and also ethers, ketones, esters, acetals and fluoroalkanes as blowing agents. The boiling points are preferably below 50° C.

CN 101880452 describes the use of alkanes having 14 to 21 carbons as phase transfer material which is used as filler in amounts of 10 to 30 parts per 100 parts polyol. There is no description here of any effects on the quality of a PU foam produced therewith with regard to its thermal conductivity.

JP 09165427 describes the use of alkanes having 9 to 12 carbons, which serve to improve the storage stability of the polyol mixture, specifically when pentane is used as blowing agent. 1 to 10 parts of the alkanes are used based on 100 parts polyol. There is no description here of any effects on the quality of a PU foam produced therewith with regard to its thermal conductivity.

US 20070066697 describes flexible PU foams of improved compression hardness through use of hydrocarbons having 10 to 70 carbons. The dosage of 0.01 to 100 pphp, 1 to 25, 2 to 8 pphp. There is no description here of a rigid foam.

JP 04018431 describes the use of unreactive components, for example paraffins or other hydrocarbons that are added in amounts of 0.1 to 10 pphp, in rigid PU foam, which is said to improve the ageing of the foam with regard to the lambda value. The examples here show that the initial lambda values worsen on addition of paraffin.

Siloxanes that do not contain any polyether modification are known mainly as additives in flexible polyurethane foam, especially moulded foam.

Examples of these are DE 2533074 A1, which describes polydimethylsiloxane for flexible foam, having chain lengths up to N=12; EP1095968A1, which describes polydimethylsiloxanes for flexible foam having preferably 7-9 silicon atoms; DE4444898 C1, which describes the production of cold-cure foams with alkylaryl-modified siloxanes containing 5-16 silicon atoms. DE 3215317 C1 describes the production of cold-cure foams with siloxanes that have been modified with allyl glycidyl ether and then reacted with amines. Here too, not more than 10 silicon atoms are present in siloxanes. EP0258600A2 describes cold-cure foams with chloropropyl-modified siloxanes having 3-20 silicon units and 1-8 side chain modifications.

However, none of these documents describes use in rigid PU foam.

EP2368927A1 describes the production of rigid PU foam using CO2 as blowing agent and two different polyol types, one based on phenolic resins, prepared from novolaks and alkylene oxides, and one based on aromatic amine polyols, prepared by alkoxylation of aromatic amines.

As well as customary PES, it is also possible here to use polydimethylsiloxanes, such as hexamethyldisiloxane in particular.

### SUMMARY

The problem addressed by the present invention was that of providing rigid polyurethane or polyisocyanurate foams that have particularly advantageous use properties, such as, in particular, low thermal conductivity and/or good surface quality.

### DETAILED DESCRIPTION

It has now been found that, surprisingly, the combined use of particular hydrocarbons HC and polyether-modified siloxanes (PES) enables the solution of this problem, and leads to the production of rigid foams having improved use properties (such as, in particular, lambda values).

More particularly, low thermal conductivity and/or good surface quality are enabled. A good fine-cell content is enabled. Foam defects can be reduced.

By the present invention, it is thus possible to produce rigid PU foam-based products, for example insulation panels or cooling units, with higher quality or to make the processes for production more efficient.

Even a very small addition of inventive hydrocarbons HC, in interplay with polyether-modified siloxanes, enables corresponding improvements.

In a particularly preferred embodiment of the invention, polyalkylsiloxanes (PAS) are additionally also used, in which case mixtures or combinations of hydrocarbons (HC), polyalkylsiloxanes (PAS) and polyether-modified siloxanes (PES) are thus used.

The inventive hydrocarbons HC have boiling points of more than 100° C., preferably more than 150° C. It is possible to use either saturated or else unsaturated hydrocarbons, and also aromatic hydrocarbons. The hydrocarbons HC may be branched or unbranched.

Preferred hydrocarbons HC are olefins, paraffins, isoparaffins or alkylbenzenes, in a preferred embodiment of the invention. Such materials are available, for example, from Sasol under the following trade names: HF-1000, LINPAR, SASOLAB, PARAFOL.

The inventive hydrocarbons HC are preferably hydrocarbons (branched, unbranched, saturated, unsaturated or aromatic) having 10 to 24 carbon atoms.

These can be prepared, for example, by oligomerization of olefins as described in DE102008007081A1 and DE102013212481A1.

It is likewise also possible to use corresponding streams of matter that are obtained in the preparation of oxo process alcohols, as described in EP1515934B1 and EP2947064A1.

Very particularly preferred inventive hydrocarbons HC are decene, dodecene, dodecane, tetradecane, tributene, tributane, tetrabutene, tetrabutane, alkylbenzenes having at least 10 carbon atoms and/or oxo process oils.

The polyether-modified siloxanes (PES) are described in detail further down. Polyether-modified siloxanes used may be the known structures according to the prior art that are suitable for production of rigid PU foams. These are known to those skilled in the art.

The polyalkylsiloxanes (PAS) usable with preference are described more specifically hereinafter. The use of polyalkylsiloxanes (PAS) is optional in the context of the invention; preferably, the use of the polyalkylsiloxanes (PAS) is obligatory; in other words, preference is given to using polyalkylsiloxanes (PAS).

In a preferred embodiment of the invention, the optionally usable polyalkylsiloxanes contain fewer than 20, preferably fewer than 15 and more preferably fewer than 11 silicon atoms.

In a preferred embodiment of the invention, the optionally usable polyalkylsiloxanes are used in combination with polyether-modified siloxanes in a mass ratio of 1:5 to 1:200.

In a preferred embodiment of the invention, the hydrocarbons HC, polyether-modified siloxanes and optional polyalkylsiloxanes may be added separately or as a mixture to the compound to be foamed.

When the optional polyalkylsiloxanes are added separately, they are preferably added in a carrier medium (solvent). Examples of useful carrier media include glycols, alkoxylates or oils of synthetic and/or natural origin.

In a preferred embodiment of the invention, the optional polyalkylsiloxanes conform to the formula (1):

Mₐ D_{b} T_{c} Q_{d} (Formula 1)

M=R¹¹R¹²R¹³SiO_{1/2}

D=R¹⁴R¹⁵SiO_{2/2}

T=R¹⁶SiO_{3/2}

Q=SiO_{4/2}

R¹¹, R¹², R¹³, R¹⁴, R¹⁵, R¹⁶=identical or different hydrocarbon radicals having 1 to 12 carbon atoms, where the hydrocarbon radicals are optionally substituted by heteroatoms, or H, preferably identical or different hydrocarbon radicals having 1-8 carbon atoms, where the hydrocarbon radicals are optionally substituted by heteroatoms, or H,

especially preferably the radicals: phenyl-, CH₃—, CH₃CH₂—, CH₂CH—ClCH₂CH₂CH₂— and H—.

a=2-6

b=0-8

c=0-4

d=0-2

with the proviso that a+b+c+d<20, preferably <15, especially preferably <11.

Preferably, c+d>0.5; especially preferably, c+d>=1.

In a further particularly preferred execution, d=0 and c>0.5; in particular, d=0 and c is not less than 1.

In a further preferred execution, c+d<0.5; especially preferably, c+d<0.1.

In a further preferred execution, R¹⁶ is different from R¹¹, R¹², R¹³, R¹⁴ and R¹⁵.

In a further preferred execution, R¹¹, R¹², R¹³ are different, and so the M unit in the siloxane bears two or three different radicals.

Preferred polyalkylsiloxanes conform to the formula 2:

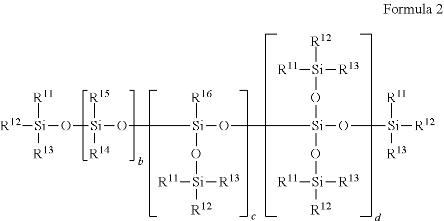

in which R¹¹ to R¹⁶ and b, c, d are as specified above.

Preferred polyalkylsiloxanes of the formula 2 conform to the formula 3 or 4:

in which b, c, d are as specified above.

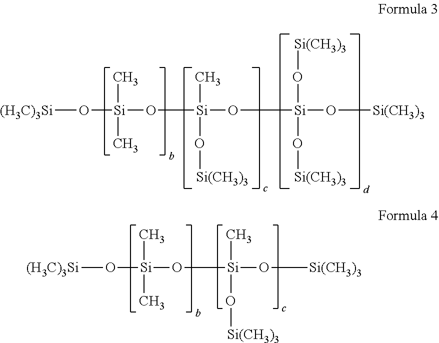

Preferred polyalkylsiloxanes are as follows:

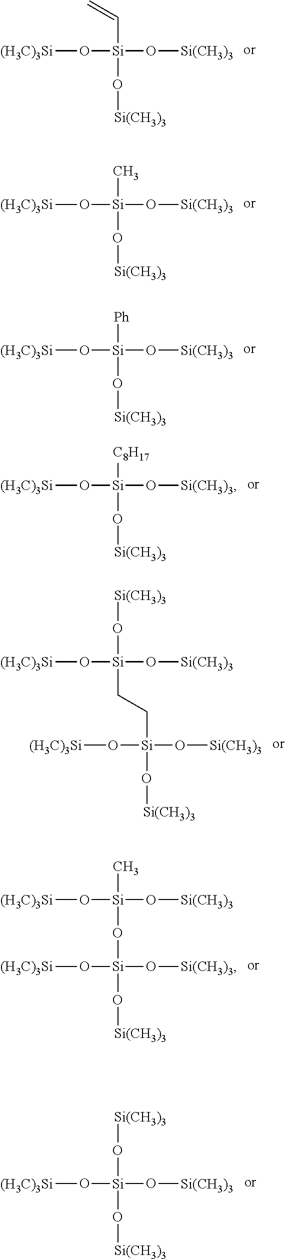

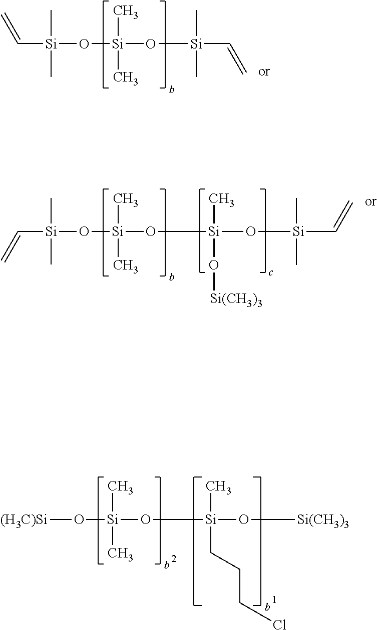

with b¹+b²=b,

where b, c are as specified above,

or

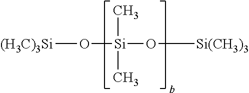

where b is as specified above,

or

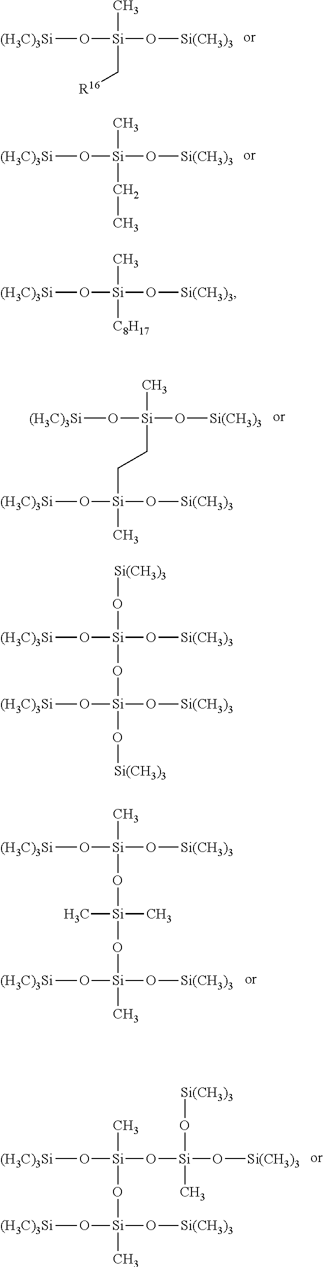

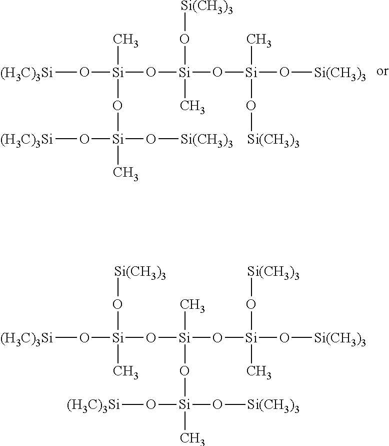

The polyether-modified siloxanes are described more specifically hereinafter. The use of polyether-modified siloxanes is obligatory in the context of the invention.

In principle, it is possible to use any polyether-modified siloxanes known from the prior art.

Preferred polyether-modified siloxanes can be described by the following formula:

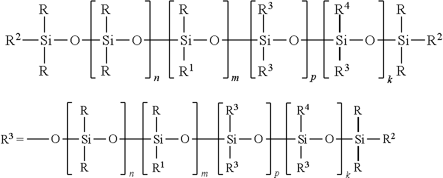

where

n is independently 0 to 500, preferably 1 to 300 and especially 2 to 150,

m is independently 0 to 60, preferably 1 to 50 and especially 1 to 30,

p is independently 0 to 10, preferably 0 or >0 to 5,

k is independently 0 to 10, preferably 0 or >0 to 5,

with the proviso that, for each molecule of the formula (1), the average number Σk of T units and the average number Σp of Q units per molecule is not greater than 50 in either case, the average number Σn of D units per molecule is not greater than 2000 and the average number Σm of the siloxy units bearing R¹ per molecule is not greater than 100,

R is independently at least one radical from the group of linear, cyclic or branched, aliphatic or aromatic, saturated or unsaturated hydrocarbon radicals having 1 up to 20 carbon atoms, but is preferably a methyl radical,

R² is independently R¹ or R,

R¹ is different from R and is independently an organic radical and/or a polyether radical,

R¹ is preferably selected from the group of

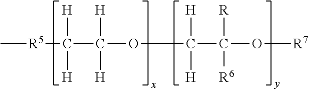

—CH₂—CH₂—CH₂—O—(CH₂—CH₂O—)ₓ—(CH₂—CH(R⁶)O—)_{y}—R⁷
—CH₂—CH₂—O—(CH₂—CH₂O—)ₓ—(CH₂—CH(R⁶)O—)_{y}—R⁷
—O—(C₂H₄O—)ₓ—(C₃H₅O—)_{y}—R⁶
—CH₂—R⁸
—CH₂—CH₂—(O)_{x′}—R⁸
—CH₂—CH₂—CH₂—O—CH₂—CH(OH)—CH₂OH

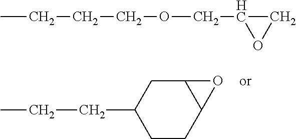

—CH₂—CH₂—CH₂—O—CH₂—C(CH₂OH)₂—CH₂—CH₃,

in which

x=0 to 100, preferably >0, especially 1 to 50,

x′=0 or 1,

y=0 to 100, preferably >0, especially 1 to 50,

R⁶ is independently an optionally substituted alkyl or aryl group having 1 to 12 carbon atoms, substituted, for example, by alkyl radicals, aryl radicals or haloalkyl or haloaryl radicals, where different substituents R⁶ may be present within any R¹ radical and/or any molecule of the formula (1), and

R⁷ is independently a hydrogen radical or an alkyl group having 1 to 4 carbon atoms, a C(O)—R⁸ group with R⁸=alkyl radical, a —CH₂—O—R⁶ group, an alkylaryl group, for example a benzyl group, or a —C(O)NH—R⁶ group,

R⁸ is a linear, cyclic or branched, optionally substituted, e.g. halogen-substituted, hydrocarbon radical having 1 to 50, preferably 9 to 45, more preferably 13 to 37, carbon atoms,

R⁵ is -D-G_{z}-
where D is a linear, cyclic or branched, optionally substituted, e.g. substituted by heteroatoms such as 0, N or halogens, saturated or unsaturated hydrocarbon radical having from 2 to 50, preferably from 3 to 45, more preferably from 4 to 37, carbon atoms, G corresponds to one of the following formulae

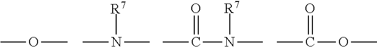

z can be 0 or 1,

where R¹ may also be bridging in the sense that two or three siloxane structures of the formula (1) may be joined via R¹, in which case R⁷ or R⁸ are correspondingly bifunctional groups, i.e. R⁵,

R⁴ may independently be R, R¹ and/or a functionalized, organic, saturated or unsaturated radical having substitution by heteroatoms, selected from the group of the alkyl, aryl, chloroalkyl, chloroaryl, fluoroalkyl, cyanoalkyl, acryloyloxyaryl, acryloyloxyalkyl, methacryloyloxyalkyl, methacryloyloxypropyl and vinyl radical,

with the proviso that at least one substituent from R¹, R² and R⁴ is not R.

R³ represents the siloxane side chains which can be formed by T and Q units. Since it is not possible to control precisely where these branching points are located, R³ once again occurs for

R³ in the formula (1). It is thus possible to obtain hyperbranched structures as in the case of, for example, dendrimers.

Particularly preferred polyether-modified siloxanes conform to the formula 5

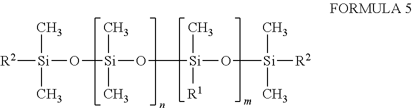

where

R¹ is the same or different and is

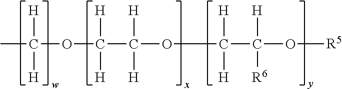

or a C₈ to C₂₂-alkyl radical,

R² is the same or different and is —CH₃ or R¹,

n+m+2=10 to 150, preferably 25 to 120,

m=0 to 25, preferably 0.5 to 15,

w=2 to 10, preferably 3,

x+y=1 to 30, preferably 5 to 25,

R⁶ is the same or different and is —CH₃, —CH₂CH₃ or phenyl radicals,

R⁵ is the same or different and is H, alkyl or acyl radicals, preferably —H, —CH₃ or —COCH₃,

where at least one radical with x+y greater than 3 must be present.

In a preferred embodiment, at least one R² radical is the same as R¹.

In a further preferred embodiment of the invention, polyether-modified siloxanes of the formula 5 are used, where the molar proportion of oxyethylene units amounts to at least 70% of the oxyalkylene units, i.e. x/(x+y)>0.7. It may also be advantageous when the polyoxyalkylene chain bears a hydrogen or a methyl group at its end and, at the same time, the molar proportion of oxyethylene units accounts for not more than 70% of the oxyalkylene units, i.e. x/(x+y)<0.7, and R⁵ is a hydrogen or methyl radical.

In a further preferred embodiment of the invention, polyethersiloxanes of the formula (5) that were hydrosilylated with inclusion of olefins are used, as a result of which R¹ consists to an extent of not less than 10 mol %, preferably to an extent of not less than 20 mol % and more preferably to an extent of not less than 40 mol % of CH₂—R⁸ where R⁸ is a linear or branched hydrocarbon having 9 to 17 carbon atoms.

In a further preferred embodiment of the invention, polyethersiloxanes of the formula (5) in which the terminal positions (also called the alpha and omega positions) on the siloxane are at least partly functionalized with R¹ moieties are used. In this case, at least 10 mol %, preferably at least 30 mol % and more preferably at least 50 mol % of the terminal positions are functionalized with R¹ radicals.

In a particularly preferred embodiment of the invention, polyethersiloxanes of the formula (5) in which a statistical average of not more than 50%, preferably not more than 45%, more preferably not more than 40%, of the total mean molar mass of the siloxane is accounted for by the cumulative molar mass of all the identical or different R¹ radicals in the siloxane are used.

In a further preferred embodiment of the invention, polyethersiloxanes of the formula (5) where the structural elements having the index n are present in a greater number than the structural elements having the index m, in such a way that the quotient n/m is at least equal to 4, preferably greater than 6, more preferably greater than 7, are used.

The hydrocarbons HC, polyether-modified siloxanes and optional polyalkylsiloxanes usable in accordance with the invention may also be used as part of compositions with different carrier media.

Examples of useful carrier media include glycols, alkoxylates or oils of synthetic and/or natural origin. In a preferred embodiment of the invention, the total proportion by mass of hydrocarbons HC, polyether-modified siloxanes and optional polyalkylsiloxanes in the finished polyurethane foam is from 0.01% to 10% by weight, preferably from 0.1% to 3% by weight.

In a particularly preferred embodiment of the invention, the use of PAS is obligatory; preference is given here to using the following combinations of PAS and PES:
a) PAS of the formula 3 with c+d>0.5 in combination with PES of the formula 5 in which the quotient n/m is at least 4, preferably greater than 6, more preferably greater than 7,
b) PAS of the formula 3 with c+d>0.5 in combination with PES of the formula 5 in which a statistical average of not more than 50%, preferably not more than 45%, more preferably not more than 40%, of the total mean molar mass of the siloxane is accounted for by the cumulative molar mass of all the identical or different R¹ radicals in the siloxane,
c) PAS of the formula 3 with c+d>0.5 in combination with PES of the formula 5 in which the polyoxyalkylene chain bears a hydrogen or a methyl group at its end and, at the same time, the molar proportion of oxyethylene units accounts for not more than 70% of the oxyalkylene units, i.e. x/(x+y)<0.7, and R⁵ is a hydrogen or methyl radical,
d) PAS of the formula 3 with c+d<0.5, especially preferably c+d<0.1, in combination with PES of the formula 5 in which the quotient n/m is at least 4, preferably greater than 6, more preferably greater than 7,
e) PAS of the formula 3 with c+d<0.5, especially preferably c+d<0.1, in combination with PES of the formula 5 in which a statistical average of not more than 50%, preferably not more than 45%, more preferably not more than 40%, of the total mean molar mass of the siloxane is accounted for by the cumulative molar mass of all the identical or different R¹ radicals in the siloxane, or
f) PAS of the formula 3 with c+d<0.5, especially preferably c+d<0.1, in combination with PES of the formula 5 in which the polyoxyalkylene chain bears a hydrogen or a methyl group at its end and, at the same time, the molar proportion of oxyethylene units accounts for not more than 70% of the oxyalkylene units, i.e. x/(x+y)<0.7, and R⁵ is a hydrogen or methyl radical.

The inventive combinations of hydrocarbons HC, polyether-modified siloxanes and optional polyalkylsiloxanes are also referred to hereinafter as “mixture”, irrespective of whether the components are supplied separately or together to the reaction mixture for production of the rigid PU foam.

The present invention further provides a composition suitable for production of rigid polyurethane or polyisocyanurate foams, comprising at least one isocyanate component, at least one polyol component, at least one foam stabilizer, at least one urethane and/or isocyanurate catalyst, water and/or blowing agent, and optionally at least one flame retardant and/or further additives, which is characterized in that an inventive mixture of hydrocarbons HC, polyether-modified siloxanes and optional polyalkylsiloxanes is present as foam stabilizer, a process for producing rigid polyurethane or polyisocyanurate foams by reacting this composition, and also the rigid polyurethane or polyisocyanurate foams obtainable thereby.

The present invention additionally provides for the use of rigid polyurethane or polyisocyanurate foams according to the invention as insulation boards and insulant, and also a cooling apparatus which includes a rigid polyurethane or polyisocyanurate foam according to the invention as insulating material.

The inventive mixture of hydrocarbons HC, polyether-modified siloxanes and optional polyalkylsiloxanes has the advantage of producing polyurethane or polyisocyanurate foams, more particularly rigid foams, which are marked by a good fine-cell content and good insulating properties and at the same time have little by way of foam defects.

Preferred compositions according to the invention that are suitable for production of rigid polyurethane or polyisocyanurate foams contain at least one isocyanate component, at least one polyol component, at least one foam stabilizer, at least one urethane and/or isocyanurate catalyst, water and/or blowing agent, and optionally at least one flame retardant and/or further additives, and are notable in that at least one inventive mixture of hydrocarbons HC, polyether-modified siloxanes and optional polyalkylsiloxanes is present.

A preferred composition of the invention contains the following constituents:
a) at least one isocyanate-reactive component, especially polyols
b) at least one polyisocyanate and/or polyisocyanate prepolymer
c) (optionally) a catalyst which accelerates or controls the reaction of polyols a) and b) with the isocyanates c)
d) an inventive mixture of hydrocarbons HC, polyether-modified siloxanes and optional polyalkylsiloxanes
e) one or more blowing agents
f) further additives, fillers, flame retardants, etc.

In the composition according to the invention, the proportion by mass of inventive mixture (i.e. hydrocarbons HC, polyether-modified siloxanes and optional polyalkylsiloxanes) d), based on 100 parts by mass of polyol component a), is preferably from 0.1 to 10 pphp, more preferably from 0.5 to 5 pphp and especially preferably from 1 to 3 pphp.

Polyols suitable as polyol component a) for the purposes of the present invention are all organic substances having one or more isocyanate-reactive groups, preferably OH groups, and also formulations thereof. Preferred polyols are all polyether polyols and/or polyester polyols and/or hydroxyl-containing aliphatic polycarbonates, especially polyether polycarbonate polyols, and/or polyols of natural origin, known as “natural oil-based polyols” (NOPs) which are customarily used for producing polyurethane systems, especially polyurethane coatings, polyurethane elastomers or foams. The polyols usually have a functionality of from 1.8 to 8 and number-average molecular weights in the range from 500 to 15 000. The polyols having OH numbers in the range from 10 to 1200 mg KOH/g are usually employed.

Polyether polyols can be prepared by known methods, for example by anionic polymerization of alkylene oxides in the presence of alkali metal hydroxides, alkali metal alkoxides or amines as catalysts and by addition of at least one starter molecule which preferably contains 2 or 3 reactive hydrogen atoms in bonded form, or by cationic polymerization of alkylene oxides in the presence of Lewis acids, for example antimony pentachloride or boron trifluoride etherate, or by double metal cyanide catalysis. Suitable alkylene oxides contain from 2 to 4 carbon atoms in the alkylene moiety. Examples are tetrahydrofuran, 1,3-propylene oxide, 1,2-butylene oxide and 2,3-butylene oxide; ethylene oxide and 1,2-propylene oxide are preferably used. The alkylene oxides can be used individually, cumulatively, in blocks, in alternation or as mixtures. Starter molecules used may especially be compounds having at least 2, preferably 2 to 8, hydroxyl groups, or having at least two primary amino groups in the molecule. Starter molecules used may, for example, be water, di-, tri- or tetrahydric alcohols such as ethylene glycol, propane-1,2- and -1,3-diol, diethylene glycol, dipropylene glycol, glycerol, trimethylolpropane, pentaerythritol, castor oil, etc., higher polyfunctional polyols, especially sugar compounds, for example glucose, sorbitol, mannitol and sucrose, polyhydric phenols, resols, for example oligomeric condensation products of phenol and formaldehyde and Mannich condensates of phenols, formaldehyde and dialkanolamines, and also melamine, or amines such as aniline, EDA, TDA, MDA and PMDA, more preferably TDA and PMDA. The choice of the suitable starter molecule is dependent on the respective field of application of the resulting polyether polyol in the production of polyurethane.

Polyester polyols are based on esters of polybasic aliphatic or aromatic carboxylic acids, preferably having 2 to 12 carbon atoms. Examples of aliphatic carboxylic acids are succinic acid, glutaric acid, adipic acid, suberic acid, azelaic acid, sebacic acid, decanedicarboxylic acid, maleic acid and fumaric acid. Examples of aromatic carboxylic acids are phthalic acid, isophthalic acid, terephthalic acid and the isomeric naphthalenedicarboxylic acids. The polyester polyols are obtained by condensation of these polybasic carboxylic acids with polyhydric alcohols, preferably of diols or triols having 2 to 12, more preferably having 2 to 6, carbon atoms, preferably trimethylolpropane and glycerol.

In a particularly preferred embodiment, polyester polyols based on aromatic carboxylic acids are used at more than 50 pphp, preferably more than 70 pphp, based on 100 parts by mass of polyol component.

In a further very particularly preferred embodiment, no polyols based on phenolic resins prepared from novolaks and alkylene oxides and no polyols based on aromatic amine polyols prepared by alkoxylation of aromatic amines are used, which means that, in this preferred embodiment, less than 20 pphp, preferably less than 10 pphp, especially less than 2 pphp and most advantageously no polyols at all based on phenolic resins prepared from novolaks and alkylene oxides and no polyols at all based on aromatic amine polyols prepared by alkoxylation of aromatic amines are used.

Polyether polycarbonate polyols are polyols containing carbon dioxide in the bonded form of the carbonate. Since carbon dioxide forms as a by-product in large volumes in many processes in the chemical industry, the use of carbon dioxide as comonomer in alkylene oxide polymerizations is of particular interest from a commercial point of view. Partial replacement of alkylene oxides in polyols with carbon dioxide has the potential to distinctly lower the costs for the production of polyols. Moreover, the use of CO2 as comonomer is very advantageous in environmental terms, since this reaction constitutes the conversion of a greenhouse gas to a polymer. The preparation of polyether polycarbonate polyols by addition of alkylene oxides and carbon dioxide onto H-functional starter substances by use of catalysts is well known. Various catalyst systems can be used here: The first generation was that of heterogeneous zinc or aluminium salts, as described, for example, in U.S. Pat. No. 3,900,424 or 3,953,383. In addition, mono- and binuclear metal complexes have been used successfully for copolymerization of CO2 and alkylene oxides (WO 2010/028362, WO 2009/130470, WO 2013/022932 or WO 2011/163133). The most important class of catalyst systems for the copolymerization of carbon dioxide and alkylene oxides is that of double metal cyanide catalysts, also referred to as DMC catalysts (U.S. Pat. No. 4,500,704, WO 2008/058913). Suitable alkylene oxides and H-functional starter substances are those also used for preparing carbonate-free polyether polyols, as described above.

Polyols based on renewable raw materials, natural oil-based polyols (NOPs), for production of polyurethane foams are of increasing interest with regard to the long-term limits in the availability of fossil resources, namely oil, coal and gas, and against the background of rising crude oil prices, and have already been described many times in such applications (WO 2005/033167; US 2006/0293400, WO 2006/094227, WO 2004/096882, US 2002/0103091, WO 2006/116456 and EP 1678232). A number of these polyols are now available on the market from various manufacturers (WO2004/020497, US2006/0229375, WO2009/058367). Depending on the base raw material (e.g. soya bean oil, palm oil or castor oil) and the subsequent workup, polyols having a different profile of properties are the result. It is possible here to distinguish essentially between two groups: a) polyols based on renewable raw materials which are modified such that they can be used to an extent of 100% for production of polyurethanes (WO2004/020497, US2006/0229375); b) polyols based on renewable raw materials which, because of the processing and properties thereof, can replace the petrochemical-based polyol only in a certain proportion (WO2009/058367).

A further class of usable polyols is that of the so-called filled polyols (polymer polyols). A feature of these is that they contain dispersed solid organic fillers up to a solids content of 40% or more. SAN, PUD and PIPA polyols are among useful polyols. SAN polyols are highly reactive polyols containing a dispersed copolymer based on styrene-acrylonitrile (SAN). PUD polyols are highly reactive polyols containing polyurea, likewise in dispersed form. PIPA polyols are highly reactive polyols containing a dispersed polyurethane, for example formed by in situ reaction of an isocyanate with an alkanolamine in a conventional polyol.

A further class of useful polyols are those which are obtained as prepolymers via reaction of polyol with isocyanate in a molar ratio of preferably 100:1 to 5:1, more preferably 50:1 to 10:1.

Such prepolymers are preferably made up in the form of a solution in polymer, and the polyol preferably corresponds to the polyol used for preparing the prepolymers.

A preferred ratio of isocyanate and polyol, expressed as the index of the formulation, i.e. as stoichiometric ratio of isocyanate groups to isocyanate-reactive groups (e.g. OH groups, NH groups) multiplied by 100, is in the range from 10 to 1000 and preferably in the range from 40 to 600. An index of 100 represents a molar reactive group ratio of 1:1.

In a preferred embodiment of the invention, the index of the formulation is in the range of 150 to 550, more preferably 200 to 500. This means that, in a preferred embodiment, a distinct excess of isocyanate groups over isocyanate-reactive groups is present. This results in trimerization reactions of the isocyanates, which thus form isocyanurates. These foam types are also referred to as polyisocyanurate (PIR) foams and are notable for improved fire characteristics, i.e. poorer burning. These foam types are preferably provided by the invention.

Isocyanate components b) used are preferably one or more organic polyisocyanates having two or more isocyanate functions. Polyol components used are preferably one or more polyols having two or more isocyanate-reactive groups.

Isocyanates suitable as isocyanate components for the purposes of this invention are all isocyanates containing at least two isocyanate groups. Generally, it is possible to use all aliphatic, cycloaliphatic, arylaliphatic and preferably aromatic polyfunctional isocyanates known per se. Isocyanates are more preferably used in a range of from 60 to 200 mol %, relative to the sum total of isocyanate-consuming components.

Specific examples here are alkylene diisocyanates having 4 to 12 carbon atoms in the alkylene radical, e.g. dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate (HMDI), cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (isophorone diisocyanate or IPDI for short), hexahydrotolylene 2,4- and 2,6-diisocyanate and also the corresponding isomer mixtures, and preferably aromatic diisocyanates and polyisocyanates, for example tolylene 2,4- and 2,6-diisocyanate (TDI) and the corresponding isomer mixtures, naphthalene diisocyanate, diethyltoluene diisocyanate, mixtures of diphenylmethane 2,4′- and 2,2′-diisocyanates (MDI) and polyphenylpolymethylene polyisocyanates (crude MDI) and mixtures of crude MDI and tolylene diisocyanates (TDI). The organic diisocyanates and polyisocyanates can be used individually or in the form of mixtures thereof. It is likewise possible to use corresponding “oligomers” of the diisocyanates (IPDI trimer based on isocyanurate, biurets, uretdiones). In addition, the use of prepolymers based on the abovementioned isocyanates is possible.

It is also possible to use isocyanates which have been modified by the incorporation of urethane, uretdione, isocyanurate, allophanate and other groups, called modified isocyanates.

Particularly suitable organic polyisocyanates which are therefore used with particular preference are various isomers of tolylene diisocyanate (tolylene 2,4- and 2,6-diisocyanate (TDI), in pure form or as isomer mixtures of various composition), diphenylmethane 4,4′-diisocyanate (MDI), “crude MDI” or “polymeric MDI” (contains the 4,4′ isomer and also the 2,4′ and 2,2′ isomers of MDI and products having more than two rings) and also the two-ring product which is referred to as “pure MDI” and is composed predominantly of 2,4′ and 4,4′ isomer mixtures, and prepolymers derived therefrom. Examples of particularly suitable isocyanates are detailed, for example, in EP 1712578, EP 1161474, WO 00/58383, US 2007/0072951, EP 1678232 and WO 2005/085310, which are hereby fully incorporated by reference.

Suitable catalysts c) in the context of the present invention are all compounds which are able to accelerate the reaction of isocyanates with OH functions, NH functions or other isocyanate-reactive groups and with isocyanates themselves. It is possible here to make use of the customary catalysts known from the prior art, including, for example, amines (cyclic, acyclic; monoamines, diamines, oligomers having one or more amino groups), ammonium compounds, organometallic compounds and metal salts, preferably those of tin, iron, bismuth and zinc. In particular, it is possible to use mixtures of a plurality of components as catalysts.

As component d) the mixtures according to the invention (i.e. hydrocarbons HC, polyether-modified siloxanes and optional polyalkylsiloxanes) are used.

The use of polyether-modified siloxanes (PES) in rigid foams is known. In the context of this invention, it is possible here to use any of those that promote foam production (stabilization, cell regulation, cell opening, etc.). These compounds are sufficiently well known from the prior art.

Corresponding PES usable in the context of this invention are described, for example, in the following patent specifications:

CN 103665385, CN 103657518, CN 103055759, CN 103044687, US 2008/0125503, US 2015/0057384, EP 1520870 A1, EP 1211279, EP 0867464, EP 0867465, EP 0275563. The aforementioned documents are hereby incorporated by reference and are considered to form part of the disclosure-content of the present invention.

The optional polyalkylsiloxanes (PAS) and polyether-modified siloxanes (PES) that are used with preference in accordance with the invention have already been described above, as have the hydrocarbons HC.

In a further preferred embodiment, the total amount of the mixture used (i.e. the totality of hydrocarbons HC, polyether-modified siloxanes and optional polyalkylsiloxanes) is such that the proportion by mass based on the finished polyurethane is 0.01% to 10% by weight, preferably 0.1% to 3% by weight.

The use of blowing agents e) is optional, depending on which foaming process is used. It is possible to work with chemical and physical blowing agents.

According to the amount of blowing agent used, a foam having high or low density is produced.

For instance, foams having densities of 5 kg/m³ to 900 kg/m³ can be produced. Preferred densities are 8 to 800, more preferably 10 to 600 kg/m³, especially 30 to 150 kg/m³.

Physical blowing agents used may be corresponding compounds having appropriate boiling points. It is likewise possible to use chemical blowing agents which react with NCO groups to liberate gases, for example water or formic acid. Examples of blowing agents include liquefied CO2, nitrogen, air, volatile liquids, for example hydrocarbons having 3, 4 or 5 carbon atoms, preferably cyclopentane, isopentane and n-pentane, hydrofluorocarbons, preferably HFC 245fa, HFC 134a and HFC 365mfc, chlorofluorocarbons, preferably HCFC 141b, hydrofluoroolefins (HFO) or hydrohaloolefins, for example 1234ze, 1234yf, 1233zd(E) or 1336mzz, oxygen compounds such as methyl formate, acetone and dimethoxymethane, or chlorinated hydrocarbons, preferably dichloromethane and 1,2-dichloroethane.

Suitable water contents for the purposes of this invention depend on whether or not one or more blowing agents are used in addition to the water. In the case of purely water-blown foams, preferred values are typically 1 to 20 pphp; when other blowing agents are used in addition, the preferred use amount is reduced to typically 0.1 to 5 pphp.

Additives f) used may be any substances which are known from the prior art and are used in the production of polyurethanes, especially polyurethane foams, for example crosslinkers and chain extenders, stabilizers against oxidative degradation (known as antioxidants), flame retardants, surfactants, biocides, cell-refining additives, cell openers, solid fillers, antistatic additives, nucleating agents, thickeners, dyes, pigments, color pastes, fragrances, and emulsifiers, etc.

The process of the invention for producing PU foams can be conducted by the known methods, for example by manual mixing or preferably by means of foaming machines. If the process is carried out by using foaming machines, it is possible to use high-pressure or low-pressure machines. The process of the invention can be carried out either batchwise or continuously.

A preferred rigid polyurethane or polyisocyanurate foam formulation in the context of this invention gives a foam density of from 5 to 900 kg/m³ and has the composition shown in Table 1.

TABLE 1
Composition of a preferred rigid polyurethane or
polyisocyanurate formulation

| | Proportion by |
|---|---|
| Component | weight |
| Polyol | 0.1 to 100 |
| Amine catalyst | 0 to 5 |
| Metal catalyst | 0 to 10 |
| Hydrocarbons HC, polyether-modified siloxanes | 0.1 to 8 |
| and optional polyalkylsiloxanes | |
| Water | 0.01 to 20 |
| Blowing agent | 0 to 40 |
| Further additives (flame retardants, etc.) | 0 to 90 |
| Isocyanate index: 10 to 1000 | |

For further preferred embodiments and configurations of the process of the invention, reference is also made to the details already given above in connection with the composition of the invention. These details are preferably applicable.

The invention further provides a rigid PU foam obtainable by the process mentioned.

In a preferred embodiment of the invention, the polyurethane foam has a density of 5 to 900 kg/m³, preferably 8 to 800, especially preferably 10 to 600 kg/m³, more particularly 30 to 150 kg/m³.

Rigid polyurethane foam or rigid PU foam is an established technical term. The known and fundamental difference between flexible foam and rigid foam is that flexible foam shows elastic characteristics and hence deformation is reversible. By contrast, rigid foam is permanently deformed. In the context of the present invention, rigid polyurethane foam is especially understood to mean a foam to DIN 7726 that has a compressive strength to DIN 53 421/DIN EN ISO 604 of advantageously ≥20 kPa, preferably >80 kPa, more preferably ≥100 kPa, further preferably ≥150 kPa, especially preferably >180 kPa. In addition, the rigid polyurethane foam, according to DIN ISO 4590, advantageously has a closed-cell content of greater than 50%, preferably greater than 80% and more preferably greater than 90%.

The rigid PU foams according to the invention can be used as or for production of insulation materials, preferably insulation boards, refrigerators, insulating foams, roof liners, packaging foams or spray foams.

Particularly in the refrigerated warehouse, refrigeration appliances and domestic appliances industry, for example for production of insulating panels for roofs and walls, as insulating material in containers and warehouses for frozen goods, and for refrigeration and freezing appliances, the PU foams of the invention can be used advantageously.

Further preferred fields of use are in motor vehicle construction, especially for production of motor vehicle inner roof liners, bodywork parts, interior trim, cooled motor vehicles, large containers, transport pallets, packaging laminates, in the furniture industry, for example for furniture parts, doors, linings, in electronics applications.

Cooling apparatuses of the invention have, as insulation material, a PU foam of the invention (polyurethane or polyisocyanurate foam).

The invention further provides for the use of the rigid PU foam as insulation material in refrigeration technology, in refrigeration equipment, in the construction sector, automobile sector, shipbuilding sector and/or electronics sector, as insulation panels, as spray foam, as one-component foam.

The subject-matter of the invention will be described by way of example below, without any intention that the invention be restricted to these illustrative embodiments. Where ranges, general formulae or classes of compounds are specified hereinbelow, these are intended to encompass not only the corresponding ranges or groups of compounds which are explicitly mentioned but also all subranges and subgroups of compounds which can be obtained by removing individual values (ranges) or compounds. When documents are cited in the context of the present description, the contents thereof, particularly with regard to the subject matter that forms the context in which the document has been cited, are considered in their entirety to form part of the disclosure content of the present invention. Unless stated otherwise, percentages are figures in percent by weight. When average values are reported below, the values in question are weight averages, unless stated otherwise. When parameters which have been determined by measurement are reported below, the measurements have been carried out at a temperature of 25° C. and a pressure of 101 325 Pa, unless stated otherwise.

The examples adduced hereinafter describe the present invention by way of example, without any intention that the invention, the scope of application of which is apparent from the entirety of the description and the claims, be restricted to the embodiments specified in the examples.

### EXAMPLES

The polyether-modified siloxanes (PES) used were the following materials:

PES No. 1, as described in WO2011/012390 A1, Example 4.

PES No. 2, as described in WO2011/012390 A1, Example 5.

PES No. 3, as described in EP 1544235 A1, Example 14.

The inventive hydrocarbons (HCs) used were the following materials:

TABLE 2
Description of the hydrocarbons (HC)

| | Name | Material (manufacturer) |
|---|---|---|
| HC No. 1 | decene | Alpha Plus 1-Decene (Chevron) |
| HC No. 2 | dodecene | Alpha Plus 1-Dodecene (Chevron) |
| HC No. 3 | dodecane | C 1012 Paraffin (Sasol) |
| HC No. 4 | tetradecane | PARAFOL ® 14-97 (Sasol) |
| HC No. 5 | tributene | (Evonik) |
| HC No. 6 | tetrabutene | (Evonik) |
| HC No. 7 | tetrabutane | (Evonik) |
| HC No. 8 | Oxoöl LS 13 | (Evonik) |
| HC No. 9 | alkylbenzene | “Hyblene 113 (Sasol)” |

The polyalkylsiloxanes (PAS) used were the following materials conforming to the formula (1), Mₐ D_{b} T_{c} Q_{d}, as defined above. These are summarized in Table 3.

TABLE 3
Description of the polyalkylsiloxanes

| Example | a | b | c | d | R¹¹ | R¹² | R¹³ | R¹⁴ | R¹⁵ | R¹⁶ |
|---|---|---|---|---|---|---|---|---|---|---|
| PAS No. 1 | 3 | 0 | 1 | 0 | Me | Me | Me | — | — | Me |
| PAS No. 2 | 3 | 0 | 1 | 0 | Me | Me | Me | — | — | vinyl |
| PAS No. 3 | 4 | 0 | 0 | 1 | Me | Me | Me | — | — | — |
| PAS No. 4 | 4 | 0 | 2 | 0 | Me | Me | Me | — | — | Me |
| PAS No. 5 | 2 | 1 | 0 | 0 | Me | Me | Me | Octyl | Me | — |
| PAS No. 6 | 2 | 1 | 0 | 0 | Me | Me | Me | Ethyl | Me | — |
| PAS No. 7 | 4 | 1 | 2 | 0 | Me | Me | Me | Me | Me | |
| PAS No. 8 | 2 | 2-4 | 0 | 0 | Me | Me | Me | Me, | Me | — |
| | | | | | | | | Cl- | | |
| | | | | | | | | propyl | | |
| PAS No. 9 | 2 | 3-5 | 0 | 0 | Me | Me | Me | Me | Me | — |
| PAS No. 10 | 2 | 3-7 | 0 | 0 | Me | Me | Me | Me | Me | — |
| PAS No. 11 | 0 | 5 | 0 | 0 | — | — | | Me | Me | — |

For the inventive production of rigid PU foams, the polyether-modified siloxanes were used in a mixture or combination together with the various hydrocarbons and polyalkylsiloxanes.

This was done using the following mixtures that are summarized in Table 4.

The following mixtures of polyethersiloxanes (PES) and hydrocarbons (H) were produced:

TABLE 4
Description of the PES/HC mixtures (overview of PES/HC
combinations)

| | | Proportion | | Proportion |
|---|---|---|---|---|
| | PES | by weight | HC | by weight |
| Mixture 1 | No. 1 | 98 | No. 1 | 2 |
| Mixture 2 | No. 1 | 98 | No. 2 | 2 |
| Mixture 3 | No. 2 | 98 | No. 1 | 2 |
| Mixture 4 | No. 2 | 98 | No. 2 | 2 |
| Mixture 5 | No. 2 | 98 | No. 3 | 2 |
| Mixture 6 | No. 2 | 96 | No. 3 | 4 |
| Mixture 7 | No. 3 | 98 | No. 3 | 2 |
| Mixture 8 | No. 3 | 98 | No. 8 | 2 |
| Mixture 9 | No. 3 | 98 | No. 4 | 2 |
| Mixture 10 | No. 3 | 98 | No. 6 | 2 |
| Mixture 11 | No. 3 | 98 | No. 7 | 2 |
| Mixture 12 | No. 3 | 98 | No. 9 | 2 |
| Mixture 13 | No. 3 | 96 | No. 8 | 4 |
| Mixture 14 | No. 3 | 96 | No. 6 | 4 |
| Mixture 15 | No. 3 | 96 | No. 3 | 4 |
| Mixture 16 | No. 3 | 98 | No. 5 | 2 |
| Mixture 17 | No. 3 | 96 | No. 5 | 4 |
| Mixture 18 | No. 3 | 90 | No. 5 | 10 |
| Mixture 19 | No. 3 | 90 | No. 8 | 10 |

In addition, both PES and HC were combined with PAS.

TABLE 5
Description of the PES/HC/PAS mixtures

| | | Proportion | | | | Proportion |
|---|---|---|---|---|---|---|
| | PES | by weight | HC | Proportion | PAS | by weight |
| Mixture 20 | No. 2 | 96 | No. 3 | 2 | No. 10 | 2 |
| Mixture 21 | No. 2 | 92 | No. 3 | 4 | No. 7 | 4 |
| Mixture 22 | No. 2 | 96 | No. 3 | 2 | No. 7 | 2 |
| Mixture 23 | No. 3 | 96 | No. 8 | 2 | No. 10 | 2 |
| Mixture 24 | No. 3 | 96 | No. 5 | 2 | No. 1 | 2 |
| Mixture 25 | No. 3 | 96 | No. 6 | 2 | No. 2 | 2 |
| Mixture 26 | No. 3 | 94 | No. 8 | 4 | No. 3 | 2 |
| Mixture 27 | No. 3 | 94 | No. 8 | 4 | No. 4 | 2 |
| Mixture 28 | No. 3 | 96 | No. 5 | 2 | No. 5 | 2 |
| Mixture 29 | No. 3 | 96 | No. 8 | 2 | No. 8 | 2 |
| Mixture 30 | No. 3 | 96 | No. 5 | 2 | No. 9 | 2 |

In accordance with the composition, the mixtures according to the invention are compared with the corresponding noninventive polyethersiloxanes in the foaming experiments which follow.

The following are compared with PES No. 1:

Mixtures 1 to 2

The following are compared with PES No. 2:

Mixtures 3 to 6, and 20 to 22

The following are compared with PES No. 3:

Mixtures 7 to 19, and 23 to 29

Foams were produced using the following raw materials:

Stepanpol PS 2352: polyester polyol from Stepan

Stepanpol PS 2412: polyester polyol from Stepan

Terate HT 5511: polyester polyol from Invista

TCPP: tris(2-chloroisopropyl) phosphate from Fyrol

Kosmos 75 from Evonik Nutrition & Care GmbH, catalyst based on potassium octoate

Polycat 5 from Evonik Nutrition & Care GmbH, amine catalyst MDI (44V20): Desmodur 44V20L from Covestro, diphenylmethane 4,4′-diisocyanate (MDI) with isomeric and higher-functionality homologues

Examples: Production of PU Foams

Foaming was carried out by manual mixing. For this purpose, the compounds according to the invention, polyols, flame retardants, catalysts, water, siloxane surfactants according to the invention or not according to the invention, hydrocarbons according to the invention and optionally polyalkylsiloxanes and blowing agents were weighed into a beaker and mixed with a disc stirrer (diameter 6 cm) at 1000 rpm for 30 seconds. The blowing agent quantity which had evaporated during the mixing operation was determined by reweighing and replenished.

Subsequently, the isocyanate (MDI) was added, and the reaction mixture was stirred with the stirrer described at 3000 rpm for 5 s.

In the case of the PIR formulations used here, for panel applications, for example building insulation, the mixture was introduced immediately into an aluminium mould of dimensions 50 cm×25 cm×7 cm which had been heated to 65° C. The use amount of foam formulation was such that the amount was sufficient for minimum filling of the mould. The foams were demoulded after 10 minutes and then stored at room temperature for 24 hours.

A cut surface in the foam was used to visually assess the degree of internal defects and the pore structure on a scale from 1 to 10, where 10 represents an impeccable foam and 1 a very significantly defective foam.

The thermal conductivity coefficient (λ value in mW/m-K) was measured on 2.5 cm-thick sheets with a device of the Hesto Lambda Control type, model HLC X206, at an average temperature of 10° C. in accordance with the specifications of standard EN12667:2001.

Table 6 summarizes the foam formulations used.

TABLE 6
(figures in parts by weight)

| Formulation Example | PIR-1 | PIR-2 | PIR 3 |
|---|---|---|---|
| PS 2412 | 100 | | |
| PS 2352 | | 100 | |
| HT 5511 | | | 100 |
| DABCO TMR 12 | 2.5 | 2.5 | 2.5 |
| Polycat 5 | 0.5 | 0.5 | 0.5 |
| Inventive mixture | 2.5 | 2.5 | 2.5 |
| TCPP | 8 | 15 | 13 |
| Water | 0.5 | 0.5 | 0.5 |
| Isopentane | 10.5 | 10.5 | 10.5 |
| Cyclopentane | 4.5 | 4.5 | 4.5 |
| MDI (44V20) | 200 | 200 | 200 |

Foaming results with the siloxane mixtures

TABLE 7
Summary of the foaming experiments with various siloxane
mixtures and foam formulations

| Foam | | Formulation | | Internal |
|---|---|---|---|---|
| Example | Inventive mixture | No. | Lambda | defects |
| Comp. 1 | PES No. 1 (noninventive) | 1 | 22.1 | 8 |
| 1 | Mixture 1 | 1 | 21.8 | 8.5 |
| 2 | Mixture 2 | 1 | 21.7 | 9 |
| Comp. 2 | PES No. 1 (noninventive) | 2 | 22.1 | 7.5 |
| 3 | Mixture 1 | 2 | 21.9 | 8.5 |
| 4 | Mixture 2 | 2 | 21.6 | 8.5 |
| Comp. 3 | PES No. 1 (noninventive) | 3 | 22.4 | 8.5 |
| 5 | Mixture 1 | 3 | 21.8 | 9 |
| 6 | Mixture 2 | 3 | 21.5 | 9 |
| Comp. 4 | PES No. 2 (noninventive) | 3 | 23.4 | 7.5 |
| 7 | Mixture 3 | 3 | 22.2 | 8.5 |
| 8 | Mixture 4 | 3 | 22.0 | 8.5 |
| Comp. 5 | PES No. 2 (noninventive) | 2 | 22.8 | 7.5 |
| 9 | Mixture 3 | 2 | 21.6 | 9 |
| 10 | Mixture 4 | 2 | 21.5 | 8.5 |
| 11 | Mixture 5 | 2 | 21.4 | 9 |
| 12 | Mixture 6 | 2 | 21.2 | 8 |
| Comp. 6 | PES No. 3 (noninventive) | 2 | 22.1 | 9 |
| 13 | Mixture 7 | 2 | 21.6 | 8.5 |
| 14 | Mixture 8 | 2 | 21.7 | 9 |
| Comp. 7 | PES No. 3 (noninventive) | 2 | 23.0 | 8.5 |
| 15 | Mixture 9 | 2 | 22.4 | 9 |
| 16 | Mixture 10 | 2 | 22.5 | 8 |
| 17 | Mixture 11 | 2 | 22.6 | 9 |
| 18 | Mixture 12 | 2 | 22.6 | 8 |
| 19 | Mixture 13 | 2 | 21.3 | 8.5 |
| 20 | Mixture 14 | 2 | 21.4 | 9 |
| 21 | Mixture 15 | 2 | 21.4 | 8 |
| 22 | Mixture 16 | 2 | 21.4 | 9 |
| 23 | Mixture 17 | 2 | 21.4 | 9 |
| 24 | Mixture 18 | 2 | 21.2 | 8.5 |
| 25 | Mixture 19 | 2 | 21.3 | 9 |

Foaming tests were likewise conducted with HC and PAS as addition to polyethersiloxanes. The results are summarized in Table 8.

TABLE 8
Summary of the foaming experiments with siloxane mixtures
containing HC and PAS in various foam formulations.

| Foam | | Formulation | | Internal |
|---|---|---|---|---|
| Example | Inventive mixture | No. | Lambda | defects |
| Comp. 8 | PES No. 2 (noninventive) | 2 | 22.0 | 8 |
| 26 | Mixture 20 | 2 | 21.2 | 8 |
| 27 | Mixture 21 | 2 | 21.0 | 8 |
| 28 | Mixture 22 | 2 | 20.6 | 8.5 |
| Comp. 9 | PES No. 3 (noninventive) | 2 | 23.1 | 8.5 |
| 29 | Mixture 23 | 2 | 21.5 | 8 |
| 30 | Mixture 24 | 2 | 21.4 | 8.5 |
| 31 | Mixture 25 | 2 | 21.6 | 8 |
| 32 | Mixture 26 | 2 | 21.4 | 8 |
| 33 | Mixture 27 | 2 | 21.3 | 8.5 |
| 34 | Mixture 28 | 2 | 21.5 | 8.5 |
| 35 | Mixture 29 | 2 | 21.4 | 8 |
| 36 | Mixture 30 | 2 | 21.4 | 8.5 |

It is clear from the experiments that the mixtures according to the invention lead to improved insulation properties.

It should be particularly emphasized here that even a very small addition of HC and PAS according to the invention leads to measurable improvements.

1. A composition for production of rigid polyurethane foam, the composition comprising at least one isocyanate component, a polyol component, optionally a catalyst that catalyses the formation of a urethane or isocyanurate bond, optionally blowing agents, where the composition additionally comprises hydrocarbons HC that have boiling points at standard pressure of >100° C., and polyether-modified siloxane.

2. The composition according to claim 1, wherein the hydrocarbons have 10 to 24 carbon atoms.

3. The composition according to claim 1, wherein the hydrocarbons are used in combination with polyether-modified siloxanes in a mass ratio of 1:5 to 1:200.

4. The composition according to claim 1, wherein the composition further comprises polyalkylsiloxanes, where the polyalkylsiloxanes contain preferably less than 20 silicon atoms,
and where the polyalkylsiloxanes in relation to the polyether-modified siloxane are preferably used in a mass ratio of 1:5 to 1:200.

5. The composition according to claim 1, wherein the proportion by mass of the total amount of hydrocarbons, polyether-modified siloxanes and optional polyalkylsiloxanes, based on 100 parts by mass of polyol component, is from 0.1 to 10 pphp.

6. The composition according to claim 4, wherein the polyalkylsiloxanes conform to the formula 1:
MₐD_{b}T_{c}Q_{d} (Formula 1)
where
M=R¹¹R¹²R¹³SiO_{1/2}
D=R¹⁴R¹⁵SiO_{2/2}
T=R¹⁶SiO_{3/2}
Q=SiO_{4/2}
where
R¹¹, R¹², R¹³, R¹⁴, R¹⁵, R¹⁶=identical or different hydrocarbon radicals having 1 to 12, where the hydrocarbon radicals are optionally substituted by heteroatoms, or else H,
and where
a=2 to 6
b=0 to 8,
c=0 to 4,
d=0 to 2,
wherein a+b+c+d<20.

7. The composition according to claim 6, wherein
c+d>0.5.

8. The composition according to claim 6, wherein
d=0 and c>0.5.

9. The composition according to claim 6, wherein
c+d<0.5.

10. The composition according to claim 6, wherein
R¹⁶ is different from R¹¹, R¹², R¹, R¹⁴ and R¹⁵,
and/or
in that R¹¹, R¹² and R¹³ are different.

11. The process for producing rigid polyurethane foam by reacting one or more polyol components with one or more isocyanate components, wherein the reaction is effected in the presence of hydrocarbons, polyether-modified siloxanes and optionally polyalkylsiloxanes, using a composition according to claim 1.

12. A process according to claim 11, wherein the components hydrocarbons, polyether-modified siloxane and optional polyalkylsiloxanes are supplied separately or together to the reaction mixture for production of the rigid PU foam.

13. A stabilizer comprising a combination of hydrocarbons, polyether-modified siloxane and optional polyalkylsiloxane for production of rigid polyurethane foams, using a composition according to claim 1.

14. A rigid polyurethane foam obtained by the process according to claim 12.

15. An insulation board comprising the rigid polyurethane foam according to claim 14.

16. The composition according to claim 1, wherein the hydrocarbons are selected from the group consisting of decene, dodecene, dodecane, tetradecane, tributene, tributane, tetrabutene, tetrabutane, alkylbenzenes having at least 10 carbon atoms and/or oxo process oils.

17. The composition according to claim 1, wherein the composition comprises polyalkylsiloxanes, where the polyalkylsiloxanes contain 11 silicon atoms,
and where the polyalkylsiloxanes in relation to the polyether-modified siloxane are used in a mass ratio of 1:5 to 1:200.

18. The composition according to claim 1, wherein the proportion by mass of the total amount of hydrocarbons, polyether-modified siloxanes and optional polyalkylsiloxanes, based on 100 parts by mass of polyol component, is from 1 to 3 pphp.

19. The composition according to claim 4, wherein the polyalkylsiloxanes conform to the formula 1:
MₐD_{b}T_{c}Q_{d} (Formula 1)
where
M=R¹¹R¹²R¹³SiO_{1/2}
D=R¹⁴R¹⁵SiO_{2/2}
T=R¹⁶SiO_{3/2}
Q=SiO_{4/2}
where
R¹¹, R¹², R¹³, R¹⁴, R¹⁵, R¹⁶=identical or different hydrocarbon radicals having 1 to 8 carbon atoms, where the hydrocarbon radicals are selected from the group consisting of phenyl-, CH₃—, CH₃CH₂—, CH₂CH—ClCH₂CH₂CH₂— and H—,
and where
a=2 to 6
b=0 to 8,
c=0 to 4,
d=0 to 2,
with the proviso that a+b+c+d<11.

20. The composition according to claim 6, wherein c+d>1.
